(19) United States
(12) Patent Application Publication
(10) Pub. No.: US 2014/0268682 A1
(43) Pub. Date: Sep. 18, 2014

(54) PORTABLE LIGHTING SYSTEM AND METHOD OF USE

(71) Applicant: Shelly Brady, Tulsa, OK (US)

(72) Inventor: Shelly Brady, Tulsa, OK (US)

(21) Appl. No.: 14/214,994

(22) Filed: Mar. 16, 2014

Related U.S. Application Data
(60) Provisional application No. 61/789,540, filed on Mar. 15, 2013.

(51) Int. Cl. F21V 21/084; F21V 33/00; F21V 21/22; F21L 4/08; F21L 4/00; F21V 21/08

(52) U.S. Cl. CPC F21V 21/084; F21L 4/00; F21V 21/08; F21V 21/22; F21L 4/08; F21V 33/004
USPC 362/105; 362/191; 362/142

(57) ABSTRACT

A portable lighting system and method of use comprising a light up frame or housing, and the light up frame or housing can be worn as a hairpiece or hairclip to support and project lights and/or a halo of light from it, while applying make-up or grooming. The system can include a removeably attached mirror. Further, the mirror alone and/or the portable lighting system and/or light up frame or housing can be attached to numerous surfaces or even worn around your neck.

### CLAIM OF PRIORITY

This application claims priority to Provisional Application for U.S. Provisional Patent No. 61/789,540 filed Mar. 15, 2013, which is incorporated herein by reference for all purposes.

### FIELD OF INVENTION

Portable accessories, more specifically, portable light-up accessories for improved personal viewing of surface or skin areas enabling administering cosmetics, make-up, and/or pharmaceuticals.

### BACKGROUND OF INVENTION

There have been many forms of travel mirrors sold in many shapes and sizes. There are also many types of mirrors that can be found in hotels, bathrooms, and when traveling. Society and adults, more specifically those that fancy cosmetics and make-up find it impracticable to apply cosmetics without a lighted make-up mirror or in general in bad lighting conditions, Most electric regular make up mirrors are bulky, heavy, and not very portable.

The present invention is easy to produce, cost effective, lightweight, very portable, and versatile in its ability to be used in many venues.

### SUMMARY OF INVENTION

The present invention embodies a portable lighting system comprising an outer housing with its inner surface at all locations touching the ambient, at least one light and/or lighting system, at least one power source, a means to switch power on and off, and at least one means for attaching to and/or removing the invention from at least one surface. The housing can be at least one of: hollow in whole or in part, curved, horseshoe shaped, circular, clamshell, partially enclosed ring, flexible, crown shaped, tiara style, loop shaped, hoop shape, frame style, a portion of torroidal in cross-section. The housing can be made of in whole or in part at least one of the following: plastic, elastic, rubber, vinyl, cloth, terrycloth, metal, wire, wood, composite materials.

At least one light and/or lighting system can comprise at least one of the following: LEDs, multi color LEDs, fiber optics, light pipes, incandescent, electroluminescent, chemical(s), laser, fluorescent lights. At least one light and/or lighting system can be a stand-alone light that functions as a flashlight, and/or spotlight. At least one light and/or lighting system can be a group of lights which conforms to the general shape of the housing and when this group of lights is illuminated it can create a halo effect upon the face and/or other body part when viewed in a mirror. The invention can further comprise control circuitry comprising of electronics and/or a microprocessor. The control circuitry can be capable of dimming at least one light and/or lighting system. The invention can further comprise at least one extendable and/or telescoping extension element from which lights can be suspended, pivoted, and/or positioned from.

At least one power source can be at least one battery and/or electric plug, transformer and/or plug-in power supply. The invention can have rechargeable batteries, dock, etc. The means to switch power on and off can be at least one of an on/off or other switch, an electrically controlled current switch including but not limited to a transistor, FET, SCR, triac, relay, remote control, hand held, motion, impact, vibration, remote control, or other type of sensor switch.

The housing and/or stand can fit around a head, neck, or other body appendage. The housing can be a hairclip or other hairpiece to hold back hair. The housing can be flexible but rigid enough so as to be capable of remaining secure when placed on a human head.

The housing can have a track or at least one other attaching device within the inner surface in which at least one removeably attached mirror and/or other surface can be inserted or removed. The removeably attached mirror can slide, attach, insert, and/or affix to the inside or other part of the housing thus creating a make-up mirror and/or a light-up make-up mirror, and/or a ring of light, or ring of light creating a halo light effect. At least one other attaching device can be at least one of suction cups, clips, magnets, hooks, adhesive, Velcro, snaps, neck ring, clamps, latches, screws, hole for a hook and/or nail or screw. The invention can further comprise of a removeably attached mirror and/or other surface. The mirror can function as a stand-alone mirror. The stand-alone mirror can be or the devise can additionally have a magnifying mirror. The stand-alone mirror can further comprise a swivel, the ability to be moveable, foldable, attachable to other surfaces including but not limited to doors, walls, windows, mirrors.

The invention additionally can comprise a stand. The stand can comprise and/or be at least one of the following: a flip stand, pop-in, slide in stand, balancing stand, stand with the ability to be affixed to and stable on another mirror, a wall, car rear view mirror, a pole, or neck.

### METHOD OF USE

The present invention also embodies method(s) of using the portable lighting system one method comprising the following steps:
if said mirror or another surface is attached to the housing, then remove the mirror or other surface from the housing; then
place the housing on the head;
switch on the light and/or lighting system;
place and/or hold and/or secure the mirror at a comfortable viewing distance and look in the mirror.

This method further comprises the additional step of the housing being capable of holding back and/or holding in place the hair.

Another method of using the portable lighting system comprises the following steps:
if the mirror or other surface is attached to the housing, then remove the mirror or other surface from the housing;
place the housing with removed mirror on an additional surface and/or mirror;
switch on the light and/or lighting system;
position yourself for optimal illumination and/or viewing.

Although preferred embodiments of the present invention have been described it will be understood by those skilled in the art that the present invention should not be limited to the described preferred embodiments. Rather, various changes and modifications can be made within the spirit and scope of the present invention.

### BRIEF DESCRIPTION OF DRAWINGS

FIG. 1 shows an embodiment of the invention showing a frontal view.

FIG. 2 shows an embodiment of the invention with a removeably attachable mirror.

FIG. 3A shows an embodiment of the invention being worn.

FIG. 3B shows person wearing the invention.

FIG. 4 shows an embodiment of the invention attached to a secondary mirror.

FIG. 5 shows alternative embodiments of invention 1.

FIG. 6 shows alternative embodiments of invention 1.

FIGS. 7A1, 7A2, 7A3, and 7A4 each depict a way the invention can fold for portability, ease, and/or convenience.

FIGS. 7B1, 7B2, 7B3, and 7B4 each depict the invention with additional attached or removeably attached magnifying mirror.

FIG. 8 depicts an embodiment of the invention with stand 50 that is removeably attached to said housing by an attaching or removably attaching devise 55 wherein said stand 50 can loop around your neck and hold the light-up mirror invention “portable lighting system” , stabilizing the mirror to be used hands free.

FIG. 9 depicts an embodiment of the invention with stand 50 that is removeably attachable to said housing wherein said stand 50 has an additional attaching devise 60 for attaching a mirror or other surface. The stand can loop around your neck and hold a mirror, stabilizing the mirror to be used hands free

### COMPONENTS

1 invention
3 housing
4 Inner surface of housing
5 lights
8 battery compartment
10 switch
12 mirror
15 attachment device
20 track
22 head
25 extensions
30 suction cups
40 secondary mirror
50 stand
55 attaching devise for stand
60 additional attaching devise
65 folding hinge
70 Magnifying mirror
75 magnifying mirror attaching devise

### DETAILED DESCRIPTIONS OF DRAWINGS

FIG. 1 shows an embodiment of the invention 1 showing a frontal view, which depicts the housing 3, which in this drawing is curved in an upside down U-like shape for easy fitting around a persons head or attaching to a mirror or other surface, with inner surface 4. FIG. 1 also depicts several lights 5 attached to the exterior surface of the housing. Also shown is power source in the form of a battery compartment 8 and an on/of switch 10. Also depicted here are types of extensions 25 from which the lights 5 can be supported. In this embodiment extensions 25 are shown pivoting back and forth.

FIG. 2 shows an embodiment of the invention 1 with a removeably attachable mirror 12. The items depicted in FIG. 1 are also depicted in FIG. 2. Also shown is an attachment device 15, which enables the invention 1 to be hung on a wall and/or other surface. Also shown in this embodiment is a track 20 in which the mirror 12 slides within.

FIG. 3A shows an embodiment of the invention 1 being worn on the head 22 of a person.

FIG. 3B shows person wearing the invention on their head 22.

FIG. 4 shows an embodiment of the invention 1 attached to a secondary mirror 40 using suction cup(s) 30.

FIG. 5 shows alternative embodiments of invention 1 that shows lights 5 that tilt, pivot, bend, and/or adjust.

FIG. 6 shows alternative embodiments of invention 1 that shows flexible lights 5 that tilt, pivot, bend, and/or adjust.

FIGS. 7A1, 7A2, 7A3, and 7A4 each depict a way the invention can fold for portability, ease, and/or convenience. FIG. 7A1 shows folding hinge 65 open and light source 5. FIG. 7A2 shows folding hinge 65 closed. FIG. 7A3 also shows folding hinge 65. FIG. 7A4 also shows suction cup(s) 30.

FIGS. 7B1, 7B2, 7B3, and 7B4 each depict the invention with additional attached or removeably attached magnifying mirror. FIG. 7B 1 shows magnifying mirror 70 and attachment 75 and folding hinge 65. FIG. 7B2 shows suction cup(s) 30. FIG. 7B3 shows folding hinge 65. FIG. 7B4 showing suction cup(s) 30.

FIG. 8 depicts an embodiment of the invention 1 with stand 50 that is removeably attached to said housing by an attaching or removably attaching devise 55 wherein said stand 50 can loop around your neck and hold the light-up mirror invention “portable lighting system” , stabilizing the mirror to be used hands free.

FIG. 9 depicts an embodiment of the invention 1 with stand 50 that is removeably attachable to said housing wherein said stand 50 has an additional attaching devise 60 for attaching a mirror 12 or other surface. The stand can loop around your neck and hold a mirror, stabilizing the mirror to be used hands free.

Although preferred embodiments of the present invention have been described it will be understood by those skilled in the art that the present invention should not be limited to the described preferred embodiments. Rather, various changes and modifications can be made within the spirit and scope of the present invention.

1. A portable lighting system comprising:
an outer housing with its inner surface at all locations touching the ambient;
at least one light and/or lighting system;
at least one power source;
a means to switch power on and off;
at least one means for attaching to and/or removing from at least one surface.

2. The system of claim 1 wherein said housing is at least one of: hollow in whole or in part, curved, horseshoe shaped, oval, circular, clamshell, partially enclosed ring, flexible, crown shaped, tiara, loop shaped, hoop shape, frame, a portion of torroidal in cross-section.

3. The system of claim 1 wherein said housing is made of in whole or in part at least one of the following: plastic, elastic, rubber, vinyl, cloth, terrycloth, metal, wire, wood, composite materials.

4. The system of claim 1 wherein said at least one light and/or lighting system comprises at least one of the following: LEDs, multi color LEDs, fiber optics, light pipes, incandescent, electroluminescent, chemical, florescent, adjustable lights, tilting lights, flexible lights, dimming lights, bending light beam or bar, laser light, bendable track lighting, flexible lights, tilting lights, pivot lights, bending lights, and/or adjustable lights.

5. The system of claim 1 wherein said at least one light and/or lighting system is a stand-alone light that functions as a flashlight, and/or spotlight.

6. The system of claim 4 wherein said at least one light and/or lighting system is a group of lights which conforms to the general shape of said housing and when said group of lights is illuminated creates a halo effect upon the face and/or other body part when viewed in a mirror.

7. The system of claim 1 further comprising control circuitry comprising of electronics and/or a microprocessor.

8. The system of claim 7 wherein said control circuitry is capable of dimming said at least one light and/or lighting system.

9. The system of claim 1 further comprising at least one extendable and/or telescoping extension element from which lights can be suspended, pivoted, and/or positioned from.

10. The system of claim 1 wherein said at least one power source is at least one battery and/or electric plug, transformer and/or plug-in power supply, rechargeable battery, rechargeable power source with or without charging station or dock.

11. The system of claim 1 wherein said means to switch power on and off is at least one of an on/off switch, an electrically controlled current switch including but not limited to a transistor, FET, SCR, triac, relay, PIR switch control, vibration switch, sensor switch, motion switch, dimmer on/off light switch

12. The system of claim 1 wherein said housing can fit around a head, neck, or other body appendage.

13. The system of claim 1 wherein said housing is a hairclip to hold back hair.

14. The system of claim 1 wherein said housing is flexible but rigid enough so as to be capable of remaining secure when placed on a human head or neck.

15. The system of claim 1 wherein said housing has a track or at least one other attaching device within the inner surface in which a removeably attached mirror and/or or other surface can be inserted or removed.

16. The system of claim 15 wherein said removeably attached mirror slides, attaches, inserts, and/or affixes to the inside of said housing thus creating a make-up mirror and/or a light-up make-up mirror, and/or light-up make-up mirror with back lighting.

17. The system of claim 15 wherein said at least one other attaching device is at least one of suction cups, clips, magnets, hooks, adhesive, Velcro, snaps. clamps, latches, screws, hole for a hook and/or nail or screw.

18. The system of claim 1 further comprising a removeably attached mirror and/or other surface.

19. The system of claim 15 wherein said mirror when removed functions as a stand-alone mirror. The system once mirror is removed functions to produce a ring of light and/or halo of light.

20. The system of claim 19 wherein said stand-alone mirror is a magnifying mirror. The system of claim 19 wherein said system additionally has at least one magnifying mirror.

21. The system of claim 19 wherein said stand-alone mirror further comprises a swivel, the ability to be moveable, foldable, attachable to other surfaces including but not limited to doors, walls, windows, mirrors, .

22. The system of claim 18 additionally comprises a stand.

23. The system of claim 22 wherein said stand comprises at least one of the following: a flip stand, pop-in, slide in stand, balancing stand, stand with the ability to be affixed to and stable on another mirror, a wall, car rear view mirror, a pole, loop shaped, part loop shaped, circular shaped, partial circle shaped, curved shaped, horseshoe shaped, neck ring, balancing ring.

24. The system of claim 22, wherein said stand can be removeably attached to said housing.

25. The system of claim 22, wherein said stand has an additional attaching devise for attaching a mirror or other surface.

26. The system of claim 22, wherein said stand is removeably attached to said housing by an attaching or removably attaching devise 55 wherein said stand 50 can loop around your neck and hold the light-up mirror invention “portable lighting system” , stabilizing the mirror to be used hands free.

27. The system of claim 22, wherein said stand is removeably attachable to said housing wherein said stand 50 has at least one of the attaching or removably attaching devise and/or an additional attaching devise 60 for attaching a mirror or other surface. The stand can loop around your neck and hold just a mirror, stabilizing the mirror to be used hands free.

28. The system of claim 1 additionally comprising a folding hinge(s).

29. A method of using the portable lighting system comprising the following steps:
if said mirror or said other surface is attached to said housing, then remove said mirror or said other surface from said housing;
place said housing on the head;
switch on said light and/or lighting system;
place and/or hold and/or secure mirror at a comfortable viewing distance and look in said mirror.

30. A method of using the portable lighting system comprising the following steps:
if said mirror or said other surface is attached to said housing, then remove said mirror or said other surface from said housing;
place housing with removed mirror on additional surface and/or mirror;
switch on said light and/or lighting system;
position yourself for optimal illumination and/or viewing.

31. The method of claim 30 comprising the additional step of said housing holding back and/or holding in place the hair.
